(19) United States
(12) Patent Application Publication
(10) Pub. No.: US 2006/0024562 A1
(43) Pub. Date: Feb. 2, 2006

(54) Power generating element for liquid fuel cell, method for producing the same, and liquid fuel cell using the same

(75) Inventors: Hiroshi Kashino, Ibaraki-shi (JP); Yasuo Arishima, Ibaraki-shi (JP); Toshihiro Nakai, Ibaraki-shi (JP); Shingo Nakamura, Ibaraki-shi (JP); Shinsuke Shibara, Ibaraki-shi (JP); Shoji Saibara, Ibaraki-shi (JP)

Correspondence Address: OSHA LIANG L.L.P., 1221 MCKINNEY STREET, SUITE 2800, HOUSTON, TX, 77010, US

(73) Assignee: Hitachi Maxell, Ltd., Osaka (JP)

(21) Appl. No.: 10/537,169

(22) PCT Filed: Nov. 22, 2004
(86) PCT No.: PCT/JP04/17364

§ 371 Date: Jun. 1, 2005

(30) Foreign Application Priority Data
Nov. 26, 2003 (JP) 2003-396187

(51) Int. Cl. H01M 4/86; H01M 4/92; H01M 4/96; H01M 4/88

(52) U.S. Cl. 429/40; 429/44; 502/101

(57) ABSTRACT

A liquid fuel cell includes a positive electrode (8) for reducing oxygen, a negative electrode (9) for oxidizing fuel, a solid electrolyte (10) placed between the positive electrode (8) and the negative electrode (9), and liquid fuel (4), wherein the positive electrode (8) and the negative electrode (9) respectively include catalyst layers (8b), (9b) with a thickness of 20 μm or more, at least one of the respective catalyst layers (8b), (9b) has a pore with a pore diameter in a range of 0.3 μm to 2.0 μm, and a pore volume of the pore is 4% or more with respect to a total pore volume. Because of this configuration, a liquid fuel cell with a high output density can be provided in which the pore configuration in the catalyst layer is optimized, and catalyst performance is exhibited sufficiently.

### TECHNICAL FIELD

The present invention relates to a liquid fuel cell, and in particular, to an electric power generating element for a liquid fuel cell, and a method for producing the same.

### BACKGROUND ART

Recently, along with the spread of a cordless appliance such as a personal computer and a mobile telephone, there is a request for the further miniaturization and increase in capacity of a secondary battery that is a power source for the cordless appliance. At present, a lithium-ion secondary battery has been put into practical use as a secondary battery that has a high energy density and can be reduced in size and weight, and there is an increasing demand for the lithium-ion secondary battery as a portable power source. However, the lithium-ion secondary battery has not reached such a level as to ensure a sufficient continuous use time, depending upon the type of a cordless appliance to be used.

Under such circumstances, as a battery that can satisfy the above-mentioned demand, there are a direct methanol type fuel cell (DMFC) using liquid fuel directly for the reaction of a cell and a polymer electrolyte fuel cell (PEFC) using hydrogen for the reaction of a cell. The DMFC has been mainly developed as a portable power source, and the PEFC has drawn attention mainly as a power source for an automobile and a household dispersion-type power source.

In the DMFC and PEFC, electric power generating elements are composed of substantially the same material. More specifically, carbon with a high specific surface area supporting platinum (Pt) or the like, for example, is used for a catalyst of a positive electrode. A proton conductive solid polymer film or the like, for example, is used for a solid electrolyte. Carbon with a high specific surface area supporting a platinum-ruthenium (PtRu) alloy or the like, for example, is used for a catalyst of a negative electrode. Although Pt is most excellent as the catalyst of the negative electrode in the PEFC, a PtRu alloy is used in order to suppress poisoning by carbon monoxide (CO) contained in a slight amount in hydrogen fuel. The largest difference between the DMFC and the PEFC lies in the following: the PEFC requires a reformer for producing hydrogen that is fuel from methanol, gasoline, natural gas, or the like, while the DMFC requires no reformer. Therefore, the DMFC can be made compact, and recently has drawn attention as a portable power source.

However, under the current circumferences, the output density of the DMFC is considerably lower than that of the PEFC. One of the reasons is that the ability of the catalyst required for oxidizing methanol at the negative electrode is not sufficient in the DMFC. The currently used most excellent catalyst of the negative electrode is a PtRu alloy used even in the PEFC. The DMFC compensates for the low catalyst ability to some degree by using the catalyst supporting the PtRu alloy at carbon in a larger amount, compared with that of the PEFC. The specific catalyst amount per electrode area of the PEFC is 0.01 mg/cm² to 0.3 mg/cm², while that of the DMFC is 0.5 mg/cm² to 20 mg/cm².

Furthermore, the DMFC requires a large amount of catalyst similarly even at the positive electrode. This is caused by the fact that methanol passes through a solid polymer film to reach the positive electrode. That is, methanol that has reached the positive electrode effects a burning reaction with oxygen on the catalyst of the positive electrode, which reduces the catalyst that can be used for the oxygen-reducing reaction that is an original battery reaction at the positive electrode. Thus, even at the positive electrode, it is necessary to use a catalyst in an amount larger than that required for the original oxygen-reducing reaction. Therefore, the DMFC requires a catalyst in an amount larger than that of the PEFC even at the positive electrode. Although the transmission of hydrogen occurs even in the PEFC, the amount thereof is small, and the influence thereof is much smaller than that of the DMFC.

Thus, in spite of the fact that the DMFC uses a catalyst in an amount larger than that of the PEFC, a satisfactory output density has not been obtained. In order to achieve the further enhancement of the output density of the DMFC in the future, it is necessary to consider the electrode configuration for enhancing the utilization factor of a catalyst. More specifically, it is necessary to optimize the pore configuration for allowing air (oxygen) and methanol to reach each reaction place in an electrode.

On the other hand, various kinds of techniques of optimizing the pore configuration in a catalyst layer of the PEFC have been proposed conventionally (see Patent Documents 1 to 6). In Patent Document 1, a solid polymer electrolyte solution in a coated catalyst layer is coagulated in a wet state, and the pore diameter of the catalyst layer is distributed in a range of 0.05 μm to 5 μm, whereby the pore configuration is optimized. In Patent Document 2, particles of 0.5 μm to 50 μm or sol particles of 10 nm to 100 nm are added to set the average pore diameter of a catalyst layer to be 0.1 μm to 10 μm and the pore volume to be 0.1 cm³/g to 1.5 cm³/g, whereby the pore configuration is optimized. In addition, as an example of a method for producing an electrode, paying attention to the pore diameter of the catalyst layer, 0.04 μm to 1.0 μm are set to be optimum values of the pore diameter in Patent Document 3, 10 μm to 30 μm are set to be optimum values of the pore diameter in Patent Document 4, 0.5 μm or less are set to be optimum values of the pore diameter in Patent Document 5, and 0.06 μm to 1 μm are set to be optimum values of the pore diameter in Patent Document 6.
Patent Document 1: JP 2000-353528 A
Patent Document 2: JP 2001-202970 A
Patent Document 3: JP 8(1996)-88007 A
Patent Document 4: JP 2002-110202 A
Patent Document 5: JP 2002-134120 A
Patent Document 6: JP 2003-151564 A

However, in the DMFC, a larger amount of catalyst is used compared with the PEFC as described above, and the catalyst layer is thicker than that of the PEFC. Therefore, in order to allow air (oxygen) and methanol to reach the inside of the catalyst layer, the pore of the catalyst layer of the DMFC needs to be larger than that of the catalyst layer of the PEFC. On the other hand, in the DMFC in which the catalyst layer is thick, when the pore of the catalyst layer is too large, the electron conductivity and ion conductivity decrease remarkably. Therefore, even when the techniques of the above-mentioned Patent Documents 1 to 6 proposed as the techniques of optimizing the pore configuration in the catalyst layer of the PEFC are directly applied to the DMFC, a sufficient output density cannot be obtained.

Thus, the pore configuration of the catalyst layer of the DMFC requires an optimization technique of its own, different from that of the PEFC. However, such an optimization technique has not been proposed at present.

### DISCLOSURE OF INVENTION

An electric power generating element for a liquid fuel cell of one or more embodiments of the present invention includes: a positive electrode for reducing oxygen; a negative electrode for oxidizing fuel; and a solid electrolyte placed between the positive electrode and the negative electrode, wherein the positive electrode and the negative electrode respectively include a catalyst layer with a thickness of 20 μm or more, at least one of the respective catalyst layers has a pore with a pore diameter in a range of 0.3 μm to 2.0 μm, and a pore volume of the pore is 4% or more with respect to a total pore volume.

Furthermore, the liquid fuel cell of one or more embodiments of the present invention includes the above-mentioned electric power generating element for a liquid fuel cell and liquid fuel.

A method for producing an electric power generating element for a liquid fuel cell of one or more embodiments of the present invention is a method for producing the above-mentioned electric power generating element for a liquid fuel cell, which includes, as a production process of the catalyst layer, dispersing a material containing a catalyst and a proton conductive material in a solvent, forming complex particles by removing the solvent to coagulate the material, and crushing the complex particles.

Furthermore, a method for producing an electric power generating element for a liquid fuel cell of one or more embodiments of the present invention is a method for producing the above-mentioned electric power generating element for a liquid fuel cell, which includes, as a production process of the catalyst layer, forming complex particles by granulating a material containing a catalyst and a proton conductive material.

According to one or more embodiments of the present invention, by optimizing the pore configuration in the catalyst layer, a liquid fuel cell with a high output density can be provided in which air (oxygen) and liquid fuel are allowed to reach each reaction place in the electrodes easily without decreasing the electron conductivity and the ion conductivity, and a catalyst ability is exhibited sufficiently.

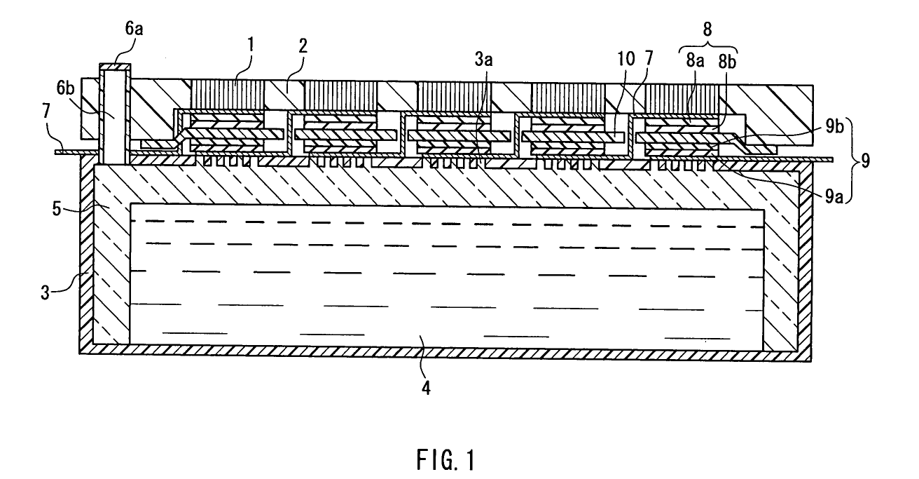

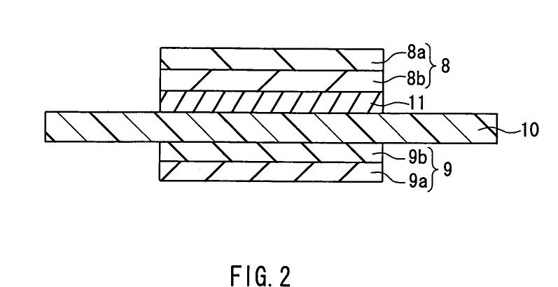

### BRIEF DESCRIPTION OF DRAWINGS

[FIG. 1] FIG. 1 is a cross-sectional view showing an example of a liquid fuel cell of one embodiment of the present invention.

[FIG. 2] FIG. 2 is a cross-sectional view showing an example of an electric power generating element for a liquid fuel cell of one embodiment of the present invention.

### DESCRIPTION OF THE INVENTION

First, an embodiment of an electric power generating element for a liquid fuel cell of the present invention will be described. An example of the electric power generating element for a liquid fuel cell of the present invention includes a positive electrode for reducing oxygen, a negative electrode for oxidizing fuel, and a solid electrolyte placed between the positive electrode and the negative electrode. The positive electrode and the negative electrode respectively include a catalyst layer with a thickness of 20 μm or more, preferably 40 μm or more. At least one of the respective catalyst layers has a pore with a pore diameter of 0.3 μm to 2.0 μm, and the pore volume is 4% or more, preferably 8% or more with respect to the total pore volume.

In the present invention, it is assumed that the total pore volume is determined with respect to a pore having a pore diameter in a range of 10 nm to 100 μm.

When the capacity of a pore with a pore diameter of 0.3 μm to 2.0 μm in the catalyst layer is 4% or more with respect to the total pore volume, an electric power generating element for a liquid fuel cell with a high output density can be provided in which air (oxygen) and liquid fuel are likely to reach the respective reaction places in the positive electrode and the negative electrode, respectively, without decreasing the electron conductivity and the ion conductivity, and each catalyst ability is exhibited sufficiently.

The upper limit value of the proportion of the pore volume preferably is 40% or less. This is because when the proportion of the pore volume exceeds 40%, it becomes difficult to produce the catalyst layer.

The reason why the thickness of the catalyst layer is set to be 20 μm or more is that the catalyst layer is allowed to hold a large amount of catalyst so as to solve the above-mentioned problems specific to the DMFC. As long as the catalyst in the current state is used, when the thickness of the catalyst layer is below 20 μm, a sufficient output density cannot be obtained. In the electric power generating element for a liquid fuel cell of the present embodiment, even when the catalyst layer is thick, an electric power generating element for a liquid fuel cell with a high output density can be provided.

The amount of the catalyst contained in the catalyst layer is desirably 0.5 mg/cm² or more per unit area, more desirably 1.5 mg/cm² or more, and most desirably 3 mg/cm² or more, so as to make it easy to obtain the effect of the present invention. On the other hand, according to one or more embodiments of the present invention, the utilization factor of the catalyst is enhanced, so that sufficient reactivity is obtained even with a relatively small amount of catalyst, whereby a sufficient output density is obtained even in the amount of 5 mg/cm² or less.

Furthermore, in the electric power generating element for a liquid fuel cell of the present embodiment, it is preferable that a positive electrode, a negative electrode, and a solid electrolyte form an electrode-electrolyte assembly, and a plurality of electrode-electrolyte assemblies are arranged on an identical plane. This is because the thickness of the battery can be decreased.

The negative electrode is configured, for example, by laminating a diffusion layer made of a porous carbon material, a conductive material supporting a catalyst, and a catalyst layer composed of a proton conductive material and a fluorine resin binder.

The negative electrode has a function of oxidizing liquid fuel such as methanol, and for example, platinum fine particles, alloy fine particles of platinum and iron, nickel, cobalt, tin, ruthenium, gold, etc., and the like are used. However, the present invention is not limited thereto.

As the conductive material that is a support of the catalyst, for example, carbon powder such as carbon black with a BET specific surface area of 10 m²/g to 2000 m²/g and a particle diameter of 20 nm to 100 nm is used. The above-mentioned catalyst is supported on the carbon powder, for example, using a colloidal method. The weight ratio between the carbon powder and the catalyst is preferably 5 parts by weight to 400 parts by weight of the catalyst with respect to 100 parts by weight of carbon powder for the following reason. In this range, sufficient catalyst activity is obtained, and the particle diameter of the catalyst does not become too large, so that the catalyst activity does not decrease.

As the proton conductive material, for example, resin having a sulfo group, such as polyperfluorosulfonic acid resin, sulfonated polyether sulfonic acid resin, or sulfonated polyimide resin can be used. However, the present invention is not limited thereto. It is preferable that the content of the proton conductive material is 2 to 200 parts by weight with respect to 100 parts by weight of catalyst-supporting carbon powder. In this range, sufficient proton conductivity is obtained, the electric resistance does not become large, and the battery performance does not decrease.

Furthermore, as the fluorine resin binder, for example, polytetrafluoroethylene (PTFE), tetrafluoroethylene-perfluoroalkylvinylether copolymer (PFA), tetrafluoroethylene-hexafluoropropylene copolymer (FEP), tetrafluoroethylene-ethylene copolymer (E/TFE), polyvinylidenefluoride (PVDF), or polychlorotrifluoroethylene (PCTFE) can be used. However, the present invention is not limited thereto. It is preferable that the content of the fluorine resin binder is 0.01 parts by weight to 100 parts by weight with respect to 100 parts by weight of catalyst-supporting carbon powder for the following reason. In this range, a sufficient binding property is obtained, electric resistant does not increase, and battery performance does not decrease.

The positive electrode is configured, for example, by laminating a diffusion layer composed of a porous carbon material and a catalyst layer composed of carbon powder supporting a catalyst, a proton conductive material, and a fluorine resin binder. The positive electrode has a function of reducing oxygen, and can be configured substantially in the same way as in the negative electrode.

In the liquid fuel cell, a so-called cross-over may arise, in which liquid fuel passes through a solid electrolyte from a negative electrode side to enter a positive electrode side, and reacts with oxygen on a catalyst of the positive electrode to degrade the potential of the positive electrode. In such a case, by providing an oxidation catalyst layer for oxidizing liquid fuel between the solid electrolyte and the catalyst layer of the positive electrode, the liquid fuel is oxidized before reaching the catalyst layer of the positive electrode, thereby suppressing the cross-over.

In order to prevent the reaction in the oxidation catalyst layer from influencing the potential of the positive electrode, it is desirable to include an insulating material in the oxidation catalyst layer to prevent the conduction between the catalyst in the oxidation catalyst layer and the catalyst layer of the positive electrode. For example, a material (complex material) obtained by allowing an insulating material to support a catalyst for oxidizing liquid fuel to be complexed can be contained in the oxidation catalyst layer.

There is no particular limit to the insulating material contained in the oxidation catalyst layer. Inorganic materials such as silica, alumina, titania, and zirconia, and resin such as PTFE, polyethylene, polypropylene, nylon, polyester, ionomer, butyl rubber, an ethylene-vinyl acetate copolymer, an ethylene-ethyl acrylate copolymer, and an ethylene-acrylic acid copolymer are used. The BET specific surface area of the insulating material preferably is 10 m²/g to 2000 m²/g, and the average particle diameter preferably is 20 nm to 100 nm. The catalyst can be supported on the insulating material, for example, by a colloidal method.

Furthermore, as the catalyst used in the oxidation catalyst layer, the same catalyst as that used in the catalyst layer of the positive electrode or the negative electrode can be used.

The weight ratio between the insulating material and the catalyst preferably is 5 to 400 parts by weight of the catalyst with respect to 100 parts by weight of the insulating material for the following reason. In this range, sufficient catalyst activity can be obtained. Furthermore, for example, in the case where a complex material is produced by a process of precipitating a catalyst on an insulating material by a colloidal method or the like, as long as the weight ratio between the insulating material and the catalyst is in the above range, the diameter of the catalyst does not become too large, and sufficient catalyst activity can be obtained.

On the other hand, in order to keep the proton conductivity between the solid electrolyte and the catalyst layer of the positive electrode, it is desirable that a proton conductive material is contained in the oxidation catalyst layer. Furthermore, by setting the oxidation catalyst layer in a porous configuration, oxygen is likely to be supplied to the catalyst in the oxidation catalyst layer, and the liquid fuel can be oxidized efficiently in the oxidation catalyst layer.

There is no particular limit to the proton conductive material contained in the oxidation catalyst layer. For example, the same proton conductive material as that contained in the catalyst layer of the positive electrode and the negative electrode can be used. It is preferable that the content of the proton conductive material contained in the oxidation catalyst layer is 5 to 900 parts by weight with respect to 100 parts by weight of the complex material supporting the catalyst for the following reason. In this range, sufficient proton conductivity is obtained, diffusion property of air is satisfactory, and liquid fuel can be oxidized sufficiently.

The oxidation catalyst layer can contain a binder, if required. There is no particular limit to the kind of the binder. However, the same binder as that used in the catalyst layer of the positive electrode or the negative electrode can be used. Furthermore, it is preferable that the content of the binder in the oxidation catalyst layer is 0.01 to 100 parts by weight with respect to 100 parts by weight of complex material supporting the catalyst for the following reason. In this range, sufficient binding property is obtained regarding the oxidation catalyst layer, and liquid fuel can be oxidized sufficiently without remarkably impairing the proton conductivity.

The solid electrolyte is composed of a material having no electron conductivity, capable of transporting a proton. For example, the solid electrolyte can be composed of a polyperfluorosulfonic acid resin film, specifically, “Nafion” (Trade Name) produced by Dupont, “Flemion” (Trade Name) produced by Asahi Glass Co., Ltd., “Aciplex” (Trade Name) produced by Asahikasei Ind. Co., Ltd., or the like. Alternatively, the solid electrolyte also can be composed of a sulfonated polyether sulfonic acid resin film, a sulfonated polyimide resin film, a sulfuric acid doped polybenzimidazole film, or the like.

Next, an embodiment of a method for producing an electric power generating element for a liquid fuel cell of the present invention will be described. An example of a method for producing an electric power generating element for a liquid fuel cell of the present invention includes, as the steps of producing a catalyst layer, dispersing a material containing a catalyst and a proton conductive material in a solvent, removing the solvent to allow the material to coagulate, thereby forming complex particles, and crushing the complex particles.

Furthermore, another example of the method for producing an electric power generating element for a liquid fuel cell of the present invention includes, as the steps of producing a catalyst layer, mixing the catalyst and the proton conductive material to granulate them, thereby forming complex particles.

By forming the complex particles, it becomes easy to control the particle diameter of the material particles contained in the catalyst layer, and to set the volume of a pore with a pore diameter of 0.3 to 2.0 μm in the catalyst layer to be 4% or more with respect to the total pore volume.

As the specific method for forming complex particles, it is preferable to use a method for dispersing carbon powder supporting a precious metal catalyst and proton conductive resin in lower saturated monovalent alcohol aqueous solution (solvent), removing the solvent to allow the dispersion to coagulate, followed by crushing, thereby forming complex particles, and a method for mixing carbon powder supporting a precious metal catalyst and proton conductive resin and granulating them, thereby forming complex particles. As the granulation method, rolling granulation, vibration granulation, mixing granulation, cracking granulation, rolling fluidized granulation, granulation by a spray dry method, or the like can be adopted.

As a method for setting the volume of a pore with a pore diameter of 0.3 to 2.0 μm in the catalyst layer to be 4% or more with respect to the total pore volume (method for controlling the distribution of holes), there also is a method for adding inorganic particles and a fibrous material relatively larger than carbon powder supporting a catalyst. For example, by adding inorganic particles such as graphite, alumina, silica, or titania, and organic fibers such as nylon, polyethylene, polyimide, or polypropylene, the distribution of holes can be limited.

Hereinafter, a method for producing an electric power generating element for a fuel cell using the above-mentioned material will be described specifically. First, carbon powder supporting the above-mentioned catalyst, a proton conductive material, and a fluorine resin binder are dispersed uniformly in a solvent composed of water and lower saturated monovalent alcohol. It is preferable that a solid content is 1 to 70% by weight with respect to the total weight of a dispersion. When the solid content is less than 1% by weight, sufficient viscosity is not obtained, and workability is unsatisfactory. When the solid content is more than 70% by weight, viscosity becomes too high, and workability becomes unsatisfactory. The dispersion can be performed using, for example, a ball mill, a jet mill, or an ultrasonic disperser. However, the present invention is not limited thereto.

Next, a slurry obtained by dispersion is dried under reduced pressure to remove a solvent. This coagulates a solid content to form complex particles. Thereafter, the complex particles are crushed to a predetermined particle diameter. The particle diameter preferably is 0.1 μm to 3000 μm. When the particle diameter is less than 0.1 μm, a hole size after an electrode is produced becomes small, which decreases the diffusibility of air (oxygen) or liquid fuel. When the particle diameter exceeds 3000 μm, a hole size becomes too large, so that the electron conductivity and ion conductivity of an electrode decrease. A crushing method can be performed using, for example, a roller mill, a hammer mill, a ball mill, or an angmill. However, the present invention is not limited thereto. Next, the crushed complex particles are uniformly dispersed in a mixed solution of water and lower saturated monovalent alcohol to obtain a slurry. At this time, it is preferable that the solid content is 1 to 70% by weight with respect to the total weight of the dispersion. When the solid content is less than 1% by weight, sufficient viscosity is not obtained, and workability is unsatisfactory. When the solid content is more than 70% by weight, viscosity becomes too high, and workability becomes unsatisfactory. The dispersion is performed to such a degree that coagulated complex particles do not collapse. The dispersion is performed using, for example, a ball mill, a jet mill, or an ultrasonic disperser. However, the present invention is not limited thereto.

Thereafter, the slurry obtained as described above is applied to a diffusion layer made of a porous carbon material, followed by drying. Then, the resultant diffusion layer is heat-pressed to allow a binder to be bound by melting, whereby an electrode is formed. The temperature of the heat press is varied depending upon the kind of a binder, and preferably is set to be a temperature equal to or higher than the glass transition temperature of a binder to be used, and equal to or lower than a temperature exceeding the glass transition temperature by 20° C. The pressure of the press preferably is 3 to 50 MPa. When the pressure of the press is less than 3 MPa, the molding of the electrode is not sufficient. When the pressure of the press exceeds 50 MPa, pores in the electrode collapse, which decreases the battery performance.

Then, a solid electrolyte is sandwiched between the electrodes so that the catalyst layers of the electrodes come into contact with the solid electrolyte, and compressed with a heat-press to produce an electrode-electrolyte assembly. The temperature of the heat-press preferably is set to be 100° C. to 180° C. The pressure of the press preferably is 3 to 50 MPa. When the temperature of the heat-press is less than 100° C. and the pressure thereof is less than 3 MPa, the formation of the electrodes is insufficient. When the temperature of the heat-press exceeds 180° C., and the pressure thereof exceeds 50 MPa, the pores in the electrodes collapse, which decreases the battery performance.

In the case of providing an oxidation catalyst layer that oxidizes liquid fuel between the solid electrolyte and the catalyst layer of the positive electrode, the oxidation catalyst layer may be formed previously on the catalyst layer of the positive electrode or the solid electrolyte, and thereafter, the positive electrode may be integrated with the solid electrolyte.

The oxidation catalyst layer is produced for example as follows. A complex material in which an insulating material supports a catalyst such as platinum, a proton conductive material, and a fluorine resin binder are dispersed uniformly in a mixed solvent containing water and lower saturated monovalent alcohol to obtain a slurry. At this time, it is preferable that the solid content is 1 to 70% by weight with respect to the total weight of the slurry. When the solid content is less than 1% by weight, sufficient viscosity is not obtained, so that workability is unsatisfactory. When the solid content exceeds 70% by weight, viscosity becomes too high, and workability becomes unsatisfactory.

There is no particular limit to the above-mentioned method for dispersing a solid content. The solid content can be dispersed by the same method as that for forming a catalyst layer of a positive electrode. More specifically, the obtained slurry is applied to the catalyst layer side of the positive electrode, followed by drying. Then, the catalyst layer with the slurry applied thereto are heat-pressed to bind a binder in the slurry by melting, whereby an oxidation catalyst layer is obtained. The temperature and pressure of the heat-press vary depending upon the kind of the binder. They may be the same as those used to form the catalyst layer of a positive electrode. When the pressure is too low, the moldability of the oxidation catalyst layer is unsatisfactory. When the pressure is too high, the pores in the oxidation catalyst layer collapse, which decreases the battery performance.

The thickness of the oxidation catalyst layer preferably is 1 to 200 μm after the production of the electrode-electrolyte assembly and before the electrode-electrolyte assembly is incorporated as a component of a fuel cell. When the thickness of the oxidation catalyst layer is too small, the amount of a catalyst for oxidizing liquid fuel and reducing oxygen becomes insufficient. When the thickness of the oxidation catalyst layer is too large, proton conductivity decreases and the battery performance degrades. Even under the condition that the electrode-electrolyte assembly is incorporated as a component of a fuel cell, it is desirable that the thickness of the oxidation catalyst layer hardly varies from what it was before the incorporation (i.e., about 1 to 200 μm).

Next, an embodiment of a liquid fuel cell of the present invention will be described with reference to the drawings. FIG. 1 is a cross-sectional view showing an example of the liquid fuel cell of the present invention. In FIG. 1, for ease of understanding of the drawings, the ratio of sizes of respective components is altered appropriately.

A positive electrode 8 is configured, for example, by laminating a diffusion layer 8a made of a porous carbon material and a catalyst layer 8b containing carbon powder supporting a catalyst.

A solid electrolyte 10 is made of a material having no electron conductivity, capable of transporting a proton.

A negative electrode 9 is composed of a diffusion layer 9a and a catalyst layer 9b, and has a function of generating a proton from fuel (i.e., a function of oxidizing fuel). The negative electrode 9 can be configured, for example, in the same way as in the above-mentioned positive electrode.

The positive electrode 8, the negative electrode 9, and a solid electrolyte 10 are laminated to form an electrode-electrolyte assembly. That is, the electrode-electrolyte assembly is composed of the positive electrode 8, the negative electrode 9, and the solid electrolyte 10 provided between the positive electrode 8 and the negative electrode 9. Furthermore, the electrode-electrolyte assembly is arranged in a plural number on an identical plane in an identical battery container.

On a side of the negative electrode 9 opposite to the solid electrolyte 10, a fuel tank 3 for storing liquid fuel 4 is provided so as to be adjacent to the negative electrode 9. As the liquid fuel 4, for example, a methanol aqueous solution, an ethanol aqueous solution, dimethyl ether, a hydrogenerated boron sodium aqueous solution, a hydrogenerated boron potassium aqueous solution, a hydrogenated boron lithium aqueous solution, or the like is used. The fuel tank 3 is composed of, for example, resin such as PTFE, hard polyvinyl chloride, polypropylene, or polyethylene, or corrosion-resistant metal such as stainless steel. When the fuel tank 3 is composed of metal, it is necessary to introduce an insulator so that the respective negative electrodes arranged in the identical battery container are not short-circuited electrically. In a portion of the fuel tank 3 in contact with the negative electrode 9, a fuel supply hole 3a is provided, and the liquid fuel 4 is supplied to the negative electrode 9 through this portion. Furthermore, a fuel suction member 5, which is impregnated with the liquid fuel 4 and supplies the liquid fuel 4 to the negative electrode 9, is provided inside the fuel tank 3 including the portion in contact with the negative electrode 9. Because of this, even if the liquid fuel 4 is consumed, the contact between the liquid fuel 4 and the negative electrode 9 is kept, so that the liquid fuel 4 can be used up. Although glass fibers can be used as the fuel suction member 5, other materials may be used as long as they are chemically stable with the size thereof hardly varied due to the impregnation of the liquid fuel 4.

On a side of the positive electrode 8 opposite to the solid electrolyte 10, a cover plate 2 is provided, and an air hole 1 is provided in a portion of the cover plate 2 in contact with the positive electrode 8. Because of this, oxygen in the air comes into contact with the positive electrode 8 through the air hole 1. At an end of the cover plate 2, a gas-liquid separation hole and fuel filling port 6b passing through the cover plate 2 and the fuel tank 3 is provided. On a side of the gas-liquid separation hole and fuel filling port 6b opposite to the fuel tank 3, a detachable gas-liquid separation film 6a is provided. The gas-liquid separation film 6a is made of a PTFE sheet having a pore, and is capable of releasing carbon dioxide generated in the discharge reaction from the fuel tank 3 without allowing the liquid fuel 4 to leak. Furthermore, by setting the gas-liquid separation film 6a to be detachable, a filling portion for supplementing the liquid fuel 4 is obtained. The gas-liquid separation hole and fuel filling portion 6b, the cover plate 2, and the air hole 1 are made of, for example, the same material as that of the fuel tank 3.

The positive electrode 8 and the negative electrode 9 of the electrode-electrolyte assembly adjacent to the positive electrode 8 are electrically connected to each other with a collector 7. The collector 7 connects the adjacent electrode-electrolyte assemblies electrically to each other in a series, and all the electrode-electrolyte assemblies arranged in the identical battery container are connected electrically in series with the collector 7. The collector 7 is composed of precious metal such as platinum and gold, corrosion-resistant metal such as stainless steel, carbon, or the like.

FIG. 1 shows the example using the electric power generating element for a liquid fuel cell in which an oxidation catalyst layer is not placed between the solid electrolyte 10 and the catalyst layer 8b of the positive electrode 8. In FIG. 1, the oxidation catalyst layer also can be placed as shown in FIG. 2. FIG. 2 is a cross-sectional view showing an example of the electric power generating element for a liquid fuel battery of the present invention, and shows an example in which an oxidation catalyst layer 11 for oxidizing liquid fuel is provided between the solid electrolyte 10 and the catalyst layer 8b of the positive electrode 8. In FIG. 2, the same components as those in FIG. 1 are denoted with the same reference numerals as those therein, and the description thereof is omitted.

Hereinafter, embodiments of the present invention will be described specifically by way of examples. The present invention is not limited to the following examples.

### EXAMPLE 1

A liquid fuel cell with the same configuration as that in FIG. 1 was produced as follows.

A catalyst layer of a positive electrode was produced as follows. First, 50 parts by weight of “Ketchen Black EC” (Trade Name) produced by Lion Akzo Co., Ltd., 7 parts by weight of platinum-supporting carbon with an average particle diameter of 5 μm supporting 50% by weight of platinum fine particles with an average particle diameter of 3 nm, 86 parts by weight of a proton conductive material “Nafion” (Trade Name, the concentration of a solid content is 5% by weight) produced by ElectroChem Inc., and 7 parts by weight of water were prepared respectively. They were mixed and dispersed uniformly with an ultrasonic disperser, and the obtained slurry was dried under reduced pressure to remove a solvent. Complex particles coagulated by drying were crushed with a planetary ball mill at a rotation number of 200 rpm for one hour. Consequently, complex particles with an average particle diameter of 10 μm were obtained.

Next, 10 parts by weight of the obtained complex particles were added to 89 parts by weight of water and one part by weight of 1-propanol, and the resultant mixture was stirred with a stirrer at a rotation number of 100 rpm for one minute, whereby a slurry with the complex particles dispersed therein was obtained. The obtained slurry was applied to one surface of a solid electrolyte “Nafion 117” (Trade Name, thickness: 180 μm) produced by Dupont so that the amount of platinum became 3.0 mg/cm², followed by drying, whereby a catalyst layer of a positive electrode was formed on one surface of the solid electrolyte.

A catalyst layer of a negative electrode was produced as follows. First, 50 parts by weight of the above-mentioned “Ketchen Black EC”, 7 parts by weight of platinum-supporting carbon with an average particle diameter of 3 μm supporting 50% by weight of platinum-ruthenium alloy (alloy weight ratio 1:1) fine particles with an average particle diameter of 3 nm, 86 parts by weight of the above-mentioned “Nafion”, and 7 parts by weight of water were prepared respectively. They were mixed and dispersed uniformly with an ultrasonic disperser, and the obtained slurry was dried under reduced pressure to remove a solvent. Complex particles coagulated by drying were crushed with a planetary ball mill at a rotation number of 200 rpm for one hour. Consequently, complex particles with an average particle diameter of 9 μm were obtained. Next, a catalyst layer of a negative electrode was formed in the same way as in the positive electrode, except that the complex particles were applied to one surface of the solid electrolyte opposite to the surface where the catalyst layer of the positive electrode has been formed so that the amount of platinum-ruthenium became 3.0 mg/cm².

Next, the laminate of the catalyst layer of the positive electrode, the solid electrolyte, and the catalyst layer of the negative electrode formed as described above was heat-pressed at 120° C. for 3 minutes under the condition of 10 MPa, whereby an electrode-electrolyte assembly was produced. The electrode area was set to be 10 cm² in both the positive and negative electrodes.

The cross-section of the obtained electrode-electrolyte assembly was observed with an electron microscope, revealing that the thickness of the catalyst layer of the positive electrode was 52 μm, and the thickness of the catalyst layer of the negative electrode was 50 μm. The pore distribution of each catalyst layer of the obtained electrode-electrolyte assembly was measured with a mercury porosimeter “Pore Sizer 9310” (Trade Name) produced by Micromeritics. Consequently, in any of the catalyst layers, the volume of a pore with a pore diameter of 0.3 μm to 2.0 μm was 10% with respect to the total pore volume.

As the diffusion layer, a carbon cloth with a thickness of 400 μm was used. Furthermore, a cover plate and a fuel tank provided on a side of the positive electrode opposite to the solid electrolyte respectively were composed of stainless steel (SUS316) coated with a phenol resin based coating “Micas A” (Trade Name) produced by Nippon Paint Co., Ltd., as an insulating coating film. A positive collector was made of a gold sheet with a thickness of 10 μm, and attached to the positive electrode with epoxy resin. As the liquid fuel, 5% by weight of methanol aqueous solution was used. A negative collector was made of the same material as that of the positive collector. A gas-liquid separation film was made of a PTFE film having a pore.

### EXAMPLE 2

A catalyst layer of a positive electrode was produced as follows. First, 50 parts by weight of “Ketchen Black EC” (Trade Name) produced by Lion Akzo Co., Ltd., 7 parts by weight of platinum-supporting carbon with an average particle diameter of 5 μm supporting 50% by weight of platinum fine particles with an average particle diameter of 3 nm, 86 parts by weight of a proton conductive material “Nafion” (Trade Name, the concentration of a solid content is 5% by weight) produced by ElectroChem Inc., and 7 parts by weight of water were prepared respectively. They were mixed and dispersed uniformly with an ultrasonic disperser, and the obtained slurry was dried under reduced pressure to remove a solvent. Complex particles coagulated by drying were crushed with a planetary ball mill at a rotation number of 50 rpm for 10 minutes. Consequently, complex particles with an average particle diameter of 120 μm were obtained. The obtained complex particles were weighed and placed so that the amount of platinum became 3.0 mg/cm², and subjected to pressure forming at a pressure of 16 MPa to form a catalyst layer of a positive electrode.

A catalyst layer of a negative electrode was produced as follows. First, 50 parts by weight of “Ketchen Black EC”, 7 parts by weight of platinum-supporting carbon with an average particle diameter of 3 μm supporting 50% by weight of platinum-ruthenium alloy (alloy weight ratio 1:1) fine particles with an average particle diameter of 3 nm, 86 parts by weight of the above-mentioned “Nafion”, and 7 parts by weight of water were prepared respectively. They were mixed and dispersed uniformly with an ultrasonic disperser, and the obtained slurry was dried under reduced pressure to remove a solvent. Complex particles coagulated by drying were crushed with a planetary ball mill at a rotation number of 50 rpm for 10 minutes. Consequently, complex particles with an average particle diameter of 110 μm were obtained. The obtained complex particles were weighed and placed so that the amount of platinum-ruthenium became 3.0 mg/cm², and subjected to pressure forming at a pressure of 16 MPa to form a catalyst layer of a negative electrode. The electrode area was set to be 10 cm² in both the positive and negative electrodes.

Next, “Nafion 117” (Trade Name, thickness: 180 μm) that was a solid electrolyte was sandwiched between the catalyst layer of the positive electrode and the catalyst layer of the negative electrode formed as described above, and the resultant laminate was heat-pressed at 120° C. for 3 minutes under the condition of 10 MPa, whereby an electrode-electrolyte assembly was produced. The electrode area was set to be 10 cm² in both the positive and negative electrodes.

The cross-section of the obtained electrode-electrolyte assembly was observed with an electron microscope, revealing that the thickness of the catalyst layer of the positive electrode was 70 μm, and the thickness of the catalyst layer of the negative electrode was 75 μm. The pore distribution of each catalyst layer of the obtained electrode-electrolyte assembly was measured with a mercury porosimeter “Pore Sizer 9310” (Trade Name) produced by Micromeritics. Consequently, in any of the catalyst layers, the volume of a pore with a pore diameter of 0.3 μm to 2.0 μm was 15% with respect to the total pore volume.

A liquid fuel cell was produced in the same way as in Example 1, except for using the above-mentioned electrode-electrolyte assembly.

### EXAMPLE 3

A catalyst layer of a positive electrode was produced as follows. First, 50 parts by weight of “Ketchen Black EC” (Trade Name) produced by Lion Akzo Co., Ltd., 7 parts by weight of platinum-supporting carbon with an average particle diameter of 5 μm supporting 50% by weight of platinum fine particles with an average particle diameter of 3 nm, 86 parts by weight of a proton conductive material “Nafion” (Trade Name, the concentration of a solid content is 5% by weight) produced by ElectroChem Inc., and 7 parts by weight of water were prepared respectively. They were mixed and dispersed uniformly with an ultrasonic disperser, and the obtained slurry was granulated by a spray dry method. Consequently, complex particles with an average particle diameter of 30 μm were obtained.

Next, 10 parts by weight of the obtained complex particles were added to 89 parts by weight of water and one part by weight of 1-propanol, and the resultant mixture was stirred with a stirrer at a rotation number of 100 rpm for one minute, whereby a slurry with the complex particles dispersed therein was obtained. The obtained slurry was applied to one surface of a solid electrolyte “Nafion 117” (Trade Name, thickness: 180 μm) produced by Dupont so that the amount of platinum became 3.0 mg/cm², followed by drying, whereby a catalyst layer of a positive electrode was formed on one surface of the solid electrolyte.

A catalyst layer of a negative electrode was produced as follows. First, 50 parts by weight of the above-mentioned “Ketchen Black EC”, 7 parts by weight of platinum-supporting carbon with an average particle diameter of 3 μm supporting 50% by weight of platinum-ruthenium alloy (alloy weight ratio 1:1) fine particles with an average particle diameter of 3 nm, 86 parts by weight of the above-mentioned “Nafion”, and 7 parts by weight of water were prepared respectively. They were mixed and dispersed uniformly with an ultrasonic disperser, and the obtained slurry was granulated by a spray dry method. Consequently, complex particles with an average particle diameter of 28 μm were obtained. Next, a catalyst layer of a negative electrode was obtained in the same way as in the positive electrode, except that the complex particles were applied to one surface of the solid electrolyte opposite to the surface where the catalyst layer of the positive electrode has been formed so that the amount of platinum-ruthenium became 3.0 mg/cm².

Next, the laminate of the catalyst layer of the positive electrode, the solid electrolyte, and the catalyst layer of the negative electrode formed as described above was heat-pressed at 120° C. for 3 minutes under the condition of 10 MPa, whereby an electrode-electrolyte assembly was produced. The electrode area was set to be 10 cm² in both the positive and negative electrodes.

The cross-section of the obtained electrode-electrolyte assembly was observed with an electron microscope, revealing that the thickness of the catalyst layer of the positive electrode was 60 μm, and the thickness of the catalyst layer of the negative electrode was 62 μm. The pore distribution of each catalyst layer of the obtained electrode-electrolyte assembly was measured with a mercury porosimeter “Pore Sizer 9310” (Trade Name) produced by Micromeritics. Consequently, in any of the catalyst layers, the volume of a pore with a pore diameter of 0.3 μm to 2.0 μm was 13% with respect to the total pore volume.

A liquid fuel cell was produced in the same way as in Example 1, except for using the above-mentioned electrode-electrolyte assembly.

### EXAMPLE 4

An oxidation catalyst layer was formed on a solid electrolyte as follows. First, 7% by weight of platinum-supporting silica with an average particle diameter of 20 nm, and 93% by weight of a proton conductive material “Nafion” (Trade Name, the concentration of a solid content is 5% by weight) produced by ElectroChem Inc. were mixed and dispersed uniformly with an ultrasonic disperser, and the obtained slurry was applied to one surface of a solid electrolyte “Nafion 117” (Trade Name, thickness: 180 μm) produced by Dupont so that the amount of platinum became 1.0 mg/cm², followed by drying, whereby an oxidation catalyst layer was formed on one surface of a solid electrolyte. The platinum-supporting silica is composed of silica with an average particles size of 20 nm and platinum fine particles with an average particle diameter of 5 nm. The weight ratio between silica and platinum fine particles is 100 parts by weight of platinum fine particles with respect to 100 parts by weight of silica. Furthermore, the oxidation catalyst layer contains 66 parts by weight of the above-mentioned “Nafion” with respect to the 100 parts by weight of platinum-supporting silica.

Furthermore, a catalyst layer of a positive electrode was produced as follows. First, 50 parts by weight of “Ketchen Black EC” (Trade Name) produced by Lion Akzo Co., Ltd., 7 parts by weight of platinum-supporting carbon with an average particle diameter of 5 μm supporting 50% by weight of platinum fine particles with an average particle diameter of 3 nm, 86 parts by weight of a proton conductive material “Nafion” (Trade Name, the concentration of a solid content is 5% by weight) produced by ElectroChem Inc., and 7 parts by weight of water were prepared respectively. They were mixed and dispersed uniformly with an ultrasonic disperser, and the obtained slurry was granulated by a spray dry method. Consequently, complex particles with an average particle diameter of 30 μm were obtained.

Next, 10 parts by weight of the obtained complex particles were added to 89 parts by weight of water and one part by weight of 1-propanol, and the resultant mixture was stirred with a stirrer at a rotation number of 100 rpm for one minute, whereby a slurry with the complex particles dispersed therein was obtained. The obtained slurry was applied to the oxidation catalyst layer provided on the solid electrolyte so that the amount of platinum became 3.0 mg/cm², followed by drying, whereby a catalyst layer of a positive electrode was formed.

A catalyst layer of a negative electrode was produced as follows. First, 50 parts by weight of the above-mentioned “Ketchen Black EC”, 7 parts by weight of platinum-supporting carbon with an average particle diameter of 3 μm supporting 50% by weight of platinum-ruthenium alloy (alloy weight ratio 1:1) fine particles with an average particle diameter of 3 nm, 86 parts by weight of the above-mentioned “Nafion”, and 7 parts by weight of water were prepared respectively. They were mixed and dispersed uniformly with an ultrasonic disperser, and the obtained slurry was granulated by a spray dry method. Consequently, complex particles with an average particle diameter of 28 μm were obtained. Next, a catalyst layer of a negative electrode was formed in the same way as in the positive electrode, except that the complex particles were applied to one surface of the solid electrolyte opposite to the surface where the catalyst layer of the positive electrode has been formed so that the amount of platinum-ruthenium became 3.0 mg/cm².

Next, the laminate of the catalyst layer of the positive electrode, the oxidation catalyst layer, the solid electrolyte, and the catalyst layer of the negative electrode formed as described above was heat-pressed at 120° C. for 3 minutes under the condition of 10 MPa, whereby an electrode-electrolyte assembly was produced. The electrode area was set to be 10 cm² in both the positive and negative electrodes.

The cross-section of the obtained electrode-electrolyte assembly was observed with an electron microscope, revealing that the thickness of the catalyst layer of the positive electrode was 60 μm, the thickness of the oxidation catalyst layer was 10 μm, and the thickness of the catalyst layer of the negative electrode was 62 μm. The pore distribution of each catalyst layer of the obtained electrode-electrolyte assembly was measured with a mercury porosimeter “Pore Sizer 9310” (Trade Name) produced by Micromeritics. Consequently, in any of the catalyst layers, the volume of a pore with a pore diameter of 0.3 μm to 2.0 μm was 13% with respect to the total pore volume.

A liquid fuel cell was produced in the same way as in Example 1, except for using the above-mentioned electrode-electrolyte assembly.

### COMPARATIVE EXAMPLE 1

A catalyst layer of a positive electrode was produced as follows. First, 50 parts by weight of “Ketchen Black EC” (Trade Name) produced by Lion Akzo Co., Ltd., 7 parts by weight of platinum-supporting carbon with an average particle diameter of 5 μm supporting 50% by weight of platinum fine particles with an average particle diameter of 3 nm, 86 parts by weight of a proton conductive material “Nafion” (Trade Name, the concentration of a solid content is 5% by weight) produced by ElectroChem Inc., and 7 parts by weight of water were prepared respectively. They were mixed and dispersed uniformly with an ultrasonic disperser, and the obtained slurry was applied to one surface of a solid electrolyte “Nafion 117” (Trade Name, thickness: 180 μm) produced by Dupont so that the amount of platinum became 3.0 mg/cm², followed by drying, whereby a catalyst layer of a positive electrode was formed on one surface of the solid electrolyte.

A catalyst layer of a negative electrode was produced as follows. First, 50 parts by weight of the above-mentioned “Ketchen Black EC”, 7 parts by weight of platinum-supporting carbon with an average particle diameter of 3 μm supporting 50% by weight of platinum-ruthenium alloy (alloy weight ratio 1:1) fine particles with an average particle diameter of 3 nm, 86 parts by weight of the above-mentioned “Nafion”, and 7 parts by weight of water were prepared respectively. They were mixed and dispersed uniformly with an ultrasonic disperser, and the obtained slurry was applied to one surface of the solid electrolyte opposite to the surface where the catalyst layer of the positive electrode has been formed so that the amount of platinum-ruthenium became 3.0 mg/cm², followed by drying, whereby a catalyst layer of a negative electrode was formed on one surface of the solid electrolyte.

Next, the laminate of the catalyst layer of the positive electrode, the solid electrolyte, and the catalyst layer of the negative electrode formed as described above was heat-pressed at 120° C. for 3 minutes under the condition of 10 MPa, whereby an electrode-electrolyte assembly was produced. The electrode area was set to be 10 cm² in both the positive and negative electrodes.

The cross-section of the obtained electrode-electrolyte assembly was observed with an electron microscope, revealing that the thickness of the catalyst layer of the positive electrode was 80 μm, and the thickness of the catalyst layer of the negative electrode was 90 μm. The pore distribution of each catalyst layer of the obtained electrode-electrolyte assembly was measured with a mercury porosimeter “Pore Sizer 9310” (Trade Name) produced by Micromeritics. Consequently, in any of the catalyst layers, the volume of a pore with a pore diameter of 0.3 μm to 2.0 μm was 2.5% with respect to the total pore volume.

A liquid fuel cell was produced in the same way as in Example 1, except for using the above-mentioned electrode-electrolyte assembly.

### COMPARATIVE EXAMPLE 2

A catalyst layer of a positive electrode was produced as follows. First, 50 parts by weight of “Ketchen Black EC” (Trade Name) produced by Lion Akzo Co., Ltd., 7 parts by weight of platinum-supporting carbon with an average particle diameter of 5 μm supporting 50% by weight of platinum fine particles with an average particle diameter of 3 nm, 86 parts by weight of a proton conductive material “Nafion” (Trade Name, the concentration of a solid content is 5% by weight) produced by ElectroChem Inc., and 7 parts by weight of water were prepared respectively. They were mixed and dispersed uniformly with an ultrasonic disperser, and the obtained slurry was dried under reduced pressure to remove a solvent. Complex particles coagulated by drying were crushed with a planetary ball mill at a rotation number of 300 rpm for 6 hours. Consequently, complex particles with an average particle diameter of 2.5 μm were obtained.

Next, 10 parts by weight of the obtained complex particles were added to 89 parts by weight of water and one part by weight of 1-propanol, and the resultant mixture was stirred with a stirrer at a rotation number of 100 rpm for one minute, whereby a slurry with the complex particles dispersed therein was obtained. The obtained slurry was applied to one surface of a solid electrolyte “Nafion 117” (Trade Name, thickness: 180 μm) produced by Dupont so that the amount of platinum became 3.0 mg/cm², followed by drying, whereby a catalyst layer of a positive electrode was formed on one surface of the solid electrolyte.

A catalyst layer of a negative electrode was produced as follows. First, 50 parts by weight of the above-mentioned “Ketchen Black EC”, 7 parts by weight of platinum-supporting carbon with an average particle diameter of 3 μm supporting 50% by weight of platinum-ruthenium alloy (alloy weight ratio 1:1) fine particles with an average particle diameter of 3 nm, 86 parts by weight of the above-mentioned “Nafion”, and 7 parts by weight of water were prepared respectively. They were mixed and dispersed uniformly with an ultrasonic disperser, and the obtained slurry was dried under reduced pressure to remove a solvent. Complex particles coagulated by drying were crushed with a planetary ball mill at a rotation number of 300 rpm for 6 hours. Consequently, complex particles with an average particle diameter of 2.5 μm were obtained. Next, a catalyst layer of a negative electrode was formed in the same way as in the positive electrode, except that the complex particles were applied to one surface of the solid electrolyte opposite to the surface where the catalyst layer of the positive electrode has been formed so that the amount of platinum-ruthenium became 3.0 mg/cm².

Next, the laminate of the catalyst layer of the positive electrode, the solid electrolyte, and the catalyst layer of the negative electrode formed as described above was heat-pressed at 120° C. for 3 minutes under the condition of 10 MPa, whereby an electrode-electrolyte assembly was produced. The electrode area was set to be 10 cm² in both the positive and negative electrodes.

The cross-section of the obtained electrode-electrolyte assembly was observed with an electron microscope, revealing that the thickness of the catalyst layer of the positive electrode was 36 μm, and the thickness of the catalyst layer of the negative electrode was 38 μm. The pore distribution of each catalyst layer of the obtained electrode-electrolyte assembly was measured with a mercury porosimeter “Pore Sizer 9310” (Trade Name) produced by Micromeritics. Consequently, in any of the catalyst layers, the volume of a pore with a pore diameter of 0.3 μm to 2.0 μm was 2.7% with respect to the total pore volume.

A liquid fuel cell was produced in the same way as in Example 1, except for using the above-mentioned electrode-electrolyte assembly.

The outputs obtained by applying a current of 20 mA per unit area of an electrode to the liquid fuel cells produced as described above at room temperature (25° C.) were measured. Table 1 shows the results together with the ratio of the volume of a pore with a pore diameter of 0.3 μm to 2.0 μm.

TABLE 1

| | Ratio of pore | Output |
|---|---|---|
| | volume (%) | (mW/cm²) |
| Example 1 | 10 | 55 |
| Example 2 | 15 | 48 |
| Example 3 | 13 | 53 |
| Example 4 | 13 | 60 |
| Comparative Example 1 | 2.5 | 30 |
| Comparative Example 2 | 2.7 | 27 |

As is apparent from Table 1, the outputs in Examples 1 to 4 are higher than those in Comparative Examples 1 and 2. The reason for this is considered as follows: the pore configuration in the catalyst layer is optimized in Examples 1 to 4. Particularly, in Example 4 in which an oxidation catalyst layer was provided between the solid electrolyte and the catalyst layer of the positive electrode, the influence of cross-over of methanol was less, whereby a higher output was obtained.

### INDUSTRIAL APPLICABILITY

As described above, a liquid fuel cell using an electric power generating element for a liquid fuel cell of the present invention exhibits the performance of a catalyst sufficiently, and enables an incomparably high electric power generation efficiency to be obtained, whereby the liquid fuel cell can be miniaturized and have a higher capacity. Therefore, when the liquid fuel cell is used as a power source for a cordless appliance such as a personal computer and a mobile telephone, the miniaturization and reduction in weight of the cordless appliance can be achieved.

1. An electric power generating element for a liquid fuel cell, comprising: a positive electrode for reducing oxygen; a negative electrode for oxidizing fuel; and a solid electrolyte placed between the positive electrode and the negative electrode,
wherein the positive electrode and the negative electrode respectively include a catalyst layer with a thickness of 20 μm or more,
at least one of the respective catalyst layers has a pore with a pore diameter in a range of 0.3 μm to 2.0 μm, and
a pore volume of the pore is 4% or more with respect to a total pore volume.

2. The electric power generating element for a liquid fuel cell according to claim 1, wherein the catalyst layer contains, as a catalyst, at least one selected from the group consisting of platinum, a platinum-iron alloy, a platinum-nickel alloy, a platinum-cobalt alloy, a platinum-tin alloy, a platinum-ruthenium alloy, and a platinum-gold alloy.

3. The electric power generating element for a liquid fuel cell according to claim 2, wherein the catalyst is supported on a conductive material.

4. The electric power generating element for a liquid fuel cell according to claim 3, wherein the conductive material is carbon powder.

5. The electric power generating element for a liquid fuel cell according to claim 1, wherein an oxidation catalyst layer for oxidizing liquid fuel is further placed between the solid electrolyte and the catalyst layer of the positive electrode.

6. The electric power generating element for a liquid fuel cell according to claim 5, wherein the oxidation catalyst layer contains an insulating material and a proton conductive material.

7. The electric power generating element for a liquid fuel cell according to claim 5, wherein the oxidation catalyst layer contains a complex material in which a catalyst oxidizing liquid fuel is supported on an insulating material.

8. The electric power generating element for a liquid fuel cell according to claim 5, wherein the oxidation catalyst layer has a porous configuration.

9. The electric power generating element for a liquid fuel cell according to claim 5, wherein a thickness of the oxidation catalyst layer is in a range of 1 μm to 200 μm.

10. A liquid fuel cell comprising the electric power generating element for a liquid fuel cell and liquid fuel, the electric power generating element for a liquid fuel cell comprising: a positive electrode for reducing oxygen: a negative electrode for oxidizing fuel: and a solid electrolyte placed between the positive electrode and the negative electrode,
wherein the positive electrode and the negative electrode respectively include a catalyst layer with a thickness of 20 μm or more,
at least one of the respective catalyst layers has a pore with a pore diameter in a range of 0.3 μm to 2.0 μm, and
a pore volume of the pore is 4% or more with respect to a total pore volume.

11. The liquid fuel cell according to claim 10, wherein the liquid fuel is a methanol aqueous solution.

12. A method for producing an electric power generating element for a liquid fuel cell comprising a positive electrode for reducing oxygen, a negative electrode for oxidizing fuel, and a solid electrolyte placed between the positive electrode and the negative electrode, the positive electrode and the negative electrode respectively including a catalyst layer with a thickness of 20 μm or more, at least one of the respective catalyst layers having a pore with a pore diameter in a range of 0.3 μm to 2.0 μm, and a pore volume of the pore being 4% or more with respect to a total pore volume, the method, as a production process of the catalyst layer, comprising:
dispersing a material containing a catalyst and a proton conductive material in a solvent;
forming complex particles by removing the solvent to coagulate the material; and
crushing the complex particles.

13. The method for producing an electric power generating element for a liquid fuel cell according to claim 12, wherein the catalyst is at least one selected from the group consisting of platinum, a platinum-iron alloy, a platinum-nickel alloy, a platinum-cobalt alloy, a platinum-tin alloy, a platinum-ruthenium alloy, and a platinum-gold alloy

14. The method for producing an electric power generating element for a liquid fuel cell according to claim 12, wherein the catalyst is supported on a conductive material.

15. The method for producing an electric power generating element for a liquid fuel cell according to claim 14, wherein the conductive material is carbon powder.

16. A method for producing an electric power generating element for a liquid fuel cell comprising a positive electrode for reducing oxygen, a negative electrode for oxidizing fuel, and a solid electrolyte placed between the positive electrode and the negative electrode, the positive electrode and the negative electrode respectively including a catalyst layer with a thickness of 20 μm or more, at least one of the respective catalyst layers having a pore with a pore diameter in a range of 0.3 μm to 2.0 μm, and a pore volume of the pore being 4% or more with respect to a total pore volume,
the method, as a production process of the catalyst layer, comprising: forming complex particles by granulating a material containing a catalyst and a proton conductive material.

17. The method for producing an electric power generating element for a liquid fuel cell according to claim 16, wherein the catalyst is at least one selected from the group consisting of platinum, a platinum-iron alloy, a platinum-nickel alloy, a platinum-cobalt alloy, a platinum-tin alloy, a platinum-ruthenium alloy, and a platinum-gold alloy

18. The method for producing an electric power generating element for a liquid fuel cell according to claim 16, wherein the catalyst is supported on a conductive material.

19. The method for producing an electric power generating element for a liquid fuel cell according to claim 18, wherein the conductive material is carbon powder.
